(19) United States
(12) Patent Application Publication
(10) Pub. No.: US 2020/0032006 A1
(43) Pub. Date: Jan. 30, 2020

(54) POWDER MATERIAL AND METHOD FOR MANUFACTURING COATED PARTICLES USED IN SAME, METHOD FOR MANUFACTURING THREE-DIMENSIONAL SHAPED OBJECT USING POWDER MATERIAL, AND THREE-DIMENSIONAL SHAPING DEVICE

(71) Applicant: Konica Minolta, Inc., Tokyo (JP)

(72) Inventor: Keisuke MIZOGUCHI, Tokyo (JP)

(21) Appl. No.: 16/484,354

(22) PCT Filed: Dec. 8, 2017
(86) PCT No.: PCT/JP2017/044164

§ 371 Date: Aug. 7, 2019

(30) Foreign Application Priority Data
Feb. 22, 2017 (JP) 2017-030904

(51) Int. Cl. C08J 3/12; B33Y 10/00; B33Y 30/00; B33Y 50/02; B33Y 70/00; B29C 64/153; B29C 64/268; B29C 64/393

(52) U.S. Cl. CPC C08J 3/126; B33Y 10/00; B33Y 30/00; B33Y 50/02; B29K 2105/251; B29C 64/153; B29C 64/268; B29C 64/393; B33Y 70/00

(57) ABSTRACT

A powder material is used in a method for manufacturing a three-dimensional shaped object, the method including: repeatedly performing preheating of a powder material containing coated particles and selective laser light irradiation of a thin layer of the powder material; and laminating together a plurality of shaped object layers of which at least some of the coated particles are fused and coupled to each other. The coated particles include a core resin and a shell material which coats the core resin and which is made of an inorganic material. An average linear expansion coefficient of the core resin at 20 to 100° C. is 5 to 240 with respect to an average linear expansion coefficient of the shell material at 20° C. to 100° C. The shell material breaks in a range between the softening temperature of the core resin and the softening temperature+50° C.

### TECHNICAL FIELD

The present invention relates to a powder material, a method for producing coated particles to be used in the powder material, a method for producing a three-dimensional shaped object using a powder material, and a three-dimensional shaping apparatus.

### BACKGROUND ART

Various methods capable of relatively easily producing a three-dimensional shaped object having a complex shape have been developed recently. Rapid prototyping and rapid manufacturing making use of such approaches are attracting attention. As one of methods for manufacturing a three-dimensional shaped object, a powder bed fusion method is known. In the powder bed fusion method, a powder material containing resin particles or metal particles is evenly spread to form a thin layer. Then, a desired position on the thin layer is irradiated with a laser beam to selectively sinter or fuse (hereinafter, also simply referred to as “fuse”) adjacent particles. That is, a finely sliced layer in the thickness direction of a three-dimensional shaped object (hereinafter, also simply referred to as a “shaped object layer”) is formed. On the shaped object layer thus formed, the powder material is further spread and irradiated with a laser beam in a repeated manner to produce a three-dimensional shaped object of a desired shape.

The powder bed fusion method has a high shaping accuracy and provides high adhesive strength between laminated shaped object layers. The method thus has an advantage of easily providing a three-dimensional shaped object having high strength. However, types of resins for use in the powder bed fusion method now are only polystyrene, polyamide 11, polyamide 12 and the like. Three-dimensional shaped objects are desired to be formed by use of a more variety of resins.

Meanwhile, the powder bed fusion method is required to perform three-dimensional shaping faster, and a powder material is occasionally preheated before laser beam irradiation. Preheating enables a powder material to melt with a lower laser irradiation dose, that is, in a shorter period. Here, for lowering the laser irradiation dose, a higher preheating temperature is preferable. With a higher preheating temperature, however, adjacent particles are likely to aggregate one another, and shaping accuracy is likely to decrease. Moreover, occurrence of such aggregation makes it difficult to reuse particles not subjected to laser beam irradiation, that is, particles that have not been used for manufacturing the shaped object. Accordingly, it has been difficult to sufficiently raise the preheating temperature with a conventional powder material.

Here, in order to prevent aggregation of a powder material, proposed are coated particles having core particles, a first coating film with which the core particles are coated, and a second coating with which the first coating film is coated and which includes a surfactant (PTL 1).

### CITATION LIST

### Patent Literature

PTL 1: Japanese Unexamined Patent Application Publication (Translation of PCT Application) No. 2005-533877

### SUMMARY OF INVENTION

### Technical Problem

The particles described in PTL 1, however, contain a material having a relatively low softening point in the first coating film. Thus, in the coated particles, aggregation is likely to occur by heating, and it has been difficult to raise the preheating temperature.

The present invention has been made in view of the above problems. That is, an object of the present invention is to provide a powder material that can be sufficiently preheated and further has reusability, a method for producing coated particles for use in the powder material, powder particles, a three-dimensional shaping method using the powder particles, and a three-dimensional shaping apparatus for performing the three-dimensional shaping method.

### Solution to Problem

A first aspect of the present invention relates to the following powder material.

[1] A powder material to be used in a method for producing a three-dimensional shaped object by repeating preheating of a powder material containing coated particles and selective laser beam irradiation onto the thin layer of the powder material to laminate a plurality of shaped object layers in which at least portion of the coated particle is fused with at least portion of another coated particle, in which the coated particle comprises a core resin and a shell material with which the core resin is coated and which is composed of an inorganic material, the average linear expansion coefficient of the core resin in the range of 20 to 100° C. is 5 to 240 based on the average linear expansion coefficient of the shell material in the range of 20 to 100° C., and the shell material breaks in the range of the softening temperature of the core resin or higher and the softening temperature+50° C. or lower.
[2] The powder material according to [1], in which the shell material of the coated particle has a thickness of 1 to 49 nm.
[3] The powder material according to [1] or [2], in which the shell material is composed of an inorganic material comprising silicon.

A second aspect of the present invention relates to the following method for producing a coated particle.

[4] A method for producing a coated particle including a core resin and a shell material with which the core resin is coated, the method including: providing a core resin, and attaching a metal alkoxide compound to a peripheral surface of the core resin and polycondensing the metal alkoxide compound.
[5] The method for producing a coated particle according to [4], in which the metal alkoxide compound is at least one member selected from the group consisting of tetraethoxysilane, tetraisopropyl orthotitanate, and zirconium butoxide.

A third aspect of the present invention relates to the following method for producing a three-dimensional shaped object.

[6] A method for producing a three-dimensional shaped object, including: forming a thin layer composed of the powder material according to any one of [1] to [3], preheating the powder material, selectively irradiating the preheated thin layer with a laser beam to form a shaped object layer in which at least portion of the coated particle is fused with at least portion of the other coated particle, the preheated thin layer being composed of the powder material, in which the forming of the thin layer, the preheating of the powder material, and the selectively irradiating of the preheated thin layer are repeated a plurality of times and the shaped object layers are laminated to form a three-dimensional shaped object.

A fourth aspect of the present invention relates to the following three-dimensional shaping apparatus.

[7] A three-dimensional shaping apparatus, including: a shaping stage; a thin layer former that forms a thin layer of the powder material according to any one of [1] to [3] on the shaping stage; a preheater that preheats the powder material; a laser irradiator that irradiates the preheated thin layer with laser to form a shaped object layer in which at least portion of the coated particle is fused with at least portion of another coated particle, the preheated thin layer being composed of the powder material; a stage supporter that supports the shaping stage at a position movable in a vertical direction of the shaping stage; and a controller that controls the thin layer former, the preheater, the laser irradiator, and the stage supporter to form the shaped object layer repeatedly and laminate the formed shaped object layers.

### Advantageous Effects of Invention

According to a powder material of the present invention, it is possible to sufficiently raise the preheating temperature on three-dimensional shaping by a powder bed fusion method. Additionally, a powder material not subjected to laser irradiation can be reused.

### BRIEF DESCRIPTION OF DRAWINGS

FIG. 1 is a schematic sectional view of a coated particle in one embodiment of the present invention.

FIG. 2 is a side view schematically showing the configuration of a three-dimensional shaping apparatus in one embodiment of the present invention.

FIG. 3 illustrates the main part of the control system of the three-dimensional shaping apparatus in one embodiment of the present invention.

### DESCRIPTION OF EMBODIMENTS

In order to solve the problems mentioned above, the present inventors have made intensive studies and experiments on powder materials for a powder bed fusion method. The present inventors have found that the problems mentioned above can be solved by employing a powder material including coated particles having a core resin and a shell material that is composed of an inorganic material and with which the core resin is coated, in which the ratio between average linear expansion coefficients thereof at 20 to 100° C. is in a predetermined range, and the shell material breaks in the range between the softening temperature of the core resin or higher and the softening temperature+50° C. or lower.

In the coated particles contained in the powder material of the present invention, the core resin is coated with the shell material composed of an inorganic material. Thus, the shell material has high heat resistance and rigidity, and even when the core resin is melted or softened by preheating, the shell material is unlikely to deform. Accordingly, it is possible to raise the preheating temperature to around the softening temperature of the core resin, and shaping is enabled with a small amount of laser energy. Coated particles are unlikely to bind to each other on preheating, and thus, coated particles not subjected to laser irradiation can be reused. Additionally, the dimensional accuracy of three-dimensional shaped object to be obtained can be improved. In the coated particles, moisture is unlikely to permeate the shell material, and there is also provided an advantage in that the core resin is unlikely to absorb moisture and deteriorate.

Meanwhile, in the coated particles, the average linear expansion coefficient of the core resin at 20 to 100° C. is 5 to 240 times the average linear expansion coefficient of the shell material at 20 to 100° C. When the particles are heated in the range between the softening temperature of the core resin or higher and the softening temperature+50° C. or lower, the shell material breaks. That is, heating the coated particles by laser irradiation to the temperature range described above enables the core resin of the particle to be fused with the core resin of the other particle to thereby easily achieve three-dimensional shaping.

Hereinbelow, a powder material, coated particles to be used in the powder material, a method for producing a three-dimensional shaped object using the powder material, and a three-dimensional shaping apparatus of the present invention will be specifically described. However, the present invention is not limited to the following embodiments.

1. Powder Material

A powder material of the present embodiment is used for production of a three-dimensional shaped object by a powder bed fusion method. More specifically, the powder material is used in a method for producing a three-dimensional shaped object by repeating preheating of the powder material containing coated particles, formation of a thin layer composed of the powder material, and selective laser beam irradiation onto the thin layer to laminate a plurality of shaped object layers in which at least portion of the coated particle is fused with at least portion of the other coated particle.

The powder material is only required to at least contain coated particles or may be composed only of coated particles. Meanwhile, the powder material may further contain materials other than the coated particles, including a laser absorbent and a flow agent, as long as fusing by laser beam irradiation is not inhibited.

1-1. Coated Particles

The coated particles have a structure in which a core resin is coated with a shell material composed of an inorganic material (hereinbelow, the structure is also referred to as a “core-shell structure”). In the present description, the core-shell structure means that, 90% or more of the surface area of the particle composed of the core resin is coated with the shell material. The area of the shell material can be determined practically by the following method. First, the cross section of a large number of coated particles is imaged by a transmission electron microscope (TEM). Then, for each of 10 coated particles optionally selected, the proportion of the area coated by the shell material to the surface area of the particle composed of the core resin is calculated. Then, when the average value for these particles is 90% or more, the coated particles are considered to have the core-shell structure.

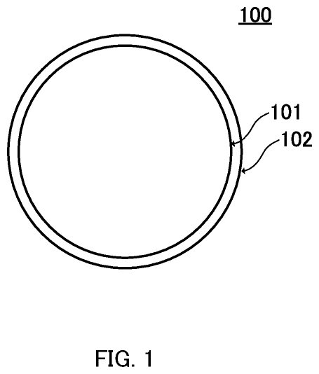

Here, as shown in the schematic sectional view of FIG. 1, in coated particle 100 of the present embodiment, core resin 101 is preferably coated with sheet-like shell material 102 having a substantially uniform thickness. The thickness of the shell material is preferably 1 to 49 nm, more preferably 10 to 45 nm, further preferably 20 to 40 nm. When the thickness of the shell material is 1 nm or more, the strength of shell material is sufficiently enhanced, and the shell material becomes unlikely to break on preheating. In contrast, when the thickness of the shell material is 49 nm or less, the shell becomes likely to break due to expansion of the core resin on laser irradiation.

The average particle size of the core resin is preferably 1 am or more and 200 am or less, more preferably 2 am or more and 150 am or less, further preferably 5 am or more and 100 am or less, further preferably 5 am or more and 70 am or less, further preferably 10 am or more and 60 am or less. When the average particle size of the core resin is 1 am or more, the powder material (coated particles) becomes easier to handle on producing a three-dimensional shaped object. When the above average particle size is 1 am or more, particles composed of the core resin are easily produced, and the production cost for the powder material does not increase. In contrast, when the above average particle size is 200 am or less, a highly accurate three-dimensional shaped object can be produced.

Further, the average particle size of the coated particles is preferably 2 am or more and 210 am or less, more preferably 10 am or more and 80 am or less. When the average particle size of the coated particles is 2 am or more, each shaped object layer to be produced by a method for producing a three-dimensional shaped object mentioned below is likely to have a sufficient thickness, and it is possible to produce a three-dimensional shaped object efficiently. In contrast, when the average particle size of the coated particles is 210 am or less, it is also possible to produce a three-dimensional shaped object having a complex shape.

The average particle size of the coated particles is a volume-average particle size measured by a dynamic light scattering method. The volume-average particle size can be measured by using a laser diffraction-type particle size analyzer equipped with a wet disperser (HELOS manufactured by Sympatec GmbH). The average particle size of the core resin and the thickness of the shell material are values determined from images obtained by imaging the cross section of a large number of coated particles by a TEM. Specifically, 10 coated particles are randomly selected from cross-sectional images of the coated particles imaged by a TEM, and the thickness of the layer composed of the shell material and the particles size of the core resin of each particle at 10 points are actually measured. Then, the average values thereof can be employed.

The circularity of the coated particles is preferably 0.95 or more, more preferably 0.96 or more, further preferably 0.97 or more. When the circularity of the coated particles is 0.95 or more, the coated particles are each likely to have a uniform volume, and a shaped object layer is likely to be formed in a desired shape. The circularity described above, which indicates the average circularity of the coated particles, is a value measured by using an “FPIA-2100” (manufactured by SYSMEX CORPORATION).

Specifically, the coated particles are moistened with a surfactant aqueous solution and ultrasonically dispersed for 1 minute. Then, the particles are measured, by using an “FPIA-2100”, in an HPF (high magnification imaging) mode at an appropriate density of the HPF detection number of 3,000 to 10,000 as a measurement condition. Within this range, a reproducible measurement value can be obtained. The circularity is calculated by the following expression.

Circularity=(perimeter of a circle having a projected area equal to that of a particle image)/(perimeter of the particle projected image)

The average circularity is an arithmetic average value obtained by dividing the sum of the circularity of each of the particles by the total number of the particles measured.

Here, the average linear expansion coefficient of the core resin at 20 to 100° C. is 5 to 240, preferably 8 to 170, further preferably 100 to 170 based on the average linear expansion coefficient of the shell material at 20 to 100° C. When the above average linear expansion coefficient of the core resin based on the above average linear expansion coefficient of the shell material is 5 or more, the shell material is likely to break as the core resin expands on laser irradiation. In contrast, when the average linear expansion coefficient of the core resin based on the average linear expansion coefficient of the shell material in the above temperature range is 240 or less, the shell material scarcely cracks by a slight temperature change, and the shell material is unlikely to break at the softening temperature of the core resin or lower. The average linear expansion coefficient of the core resin at 20 to 100° C. is preferably 30 to 120, more preferably 80 to 100. When the average linear expansion coefficient of the core resin at 20 to 100° C. is in the range, a three-dimensional shaped object to be obtained is unlikely to deform by heat, and the dimensional accuracy is likely to increase. The average linear expansion coefficient of each of the core resin and the shell material at 20 to 100° C., which is a value unique to a resin constituting the core resin or an inorganic material constituting the shell material, can be identified by thermomechanical analysis (TMA) in compliance with JIS K7197(1991), for example.

When the coated particles of the present embodiment are irradiated with a laser beam in a method for producing a three-dimensional shaped object mentioned below, the shell material breaks in the temperature range between the softening temperature of the core resin or higher and the softening temperature+50° C. or lower, and the core resin of a particle eluted onto the surface of the shell material is fused with the core resin of another particle. The broken shell material is usually dispersed in the shaped object. The “softening temperature of the core resin” herein is a temperature to be determined as follows. An aluminum plate having a diameter of 5 cm on which 1 g of core resin having an average particle size of 50 μm is spread is placed on a hot plate, and the temperature of the hot plate is raised in increments of 5° C. Then, the fusing state of the core resin is examined at each temperature, and the temperature at which the beginning of the fusing is observed is taken as the softening temperature of the core resin. Meanwhile, “the break of the shell material” herein means that the shell material cracks and a portion of the core resin is eluted to outside the shell material.

The above core resin is not particularly limited as long as being a thermoplastic resin capable of melting by preheating and heating by laser irradiation. The core resin is appropriately selected depending on a desired type of three-dimensional shaped object and a method for forming a three-dimensional shaped object. As the thermoplastic resin, resins contained in particles for a common powder bed fusion method can be used. The core resin may contain one thermoplastic resin or may contain two or more thermoplastic resins.

When the softening temperature of the thermoplastic resin is extremely high, it is necessary to heat the core resin to a high temperature so as to melt on forming a three-dimensional shaped object, and it takes a longer time to form a three-dimensional shaped object. Thus, the softening temperature of the thermoplastic resin is preferably 300° C. or lower, more preferably 230° C. or lower. Meanwhile, from the viewpoint of the heat resistance of a three-dimensional shaped object to be obtained and the like, the softening temperature of the thermoplastic resin is preferably 100° C. or higher, more preferably 150° C. or higher. The softening temperature of the core resin can be adjusted by the type of thermoplastic resin constituting the core resin.

Examples of the above thermoplastic resin constituting the core resin include crystalline resins such as polyethylene, polypropylene, nylon, polyacetal, polyethylene terephthalate (PET), polyphenyl sulfide, polyetheretherketone (PEEK), and crystalline polyester; and non-crystalline resins such as polystyrene, polyurethane, polyvinyl chloride, acrylonitrile-butadiene-styrene copolymers (ABS), acryl polymers, polycarbonate, ethylene-vinyl acetate copolymers (EVA), styrene-acrylonitrile copolymers (SAN), polyarylate, polyphenylene ether, and polycaprolactone.

It has been difficult to improve the shaping accuracy of non-crystalline resins, among these resins, by a conventional method, but the coated particles having the core-shell structure of the present embodiment can improve the shaping accuracy. From such a viewpoint, the material for the core resin may be a non-crystalline resin. When a non-crystalline resin is used as the material for the core resin, it can be said that the particle structure is more useful.

Meanwhile, the shell material with which the core resin is coated is not particularly limited as long as the material is composed of an inorganic material and has a ratio of the average linear expansion coefficient to that of the core resin in the above range, and is appropriately selected depending on the type of core resin. Examples of the inorganic resin constituting the shell material include silicon dioxide, titanium oxide, and zirconia. Of these, the inorganic material is preferably one containing silicon. The inorganic material containing silicon has a relatively small linear expansion coefficient, and the ratio of the average linear expansion coefficient to that of the core resin mentioned above is likely to be in the above range.

1-2. Other Materials

As mentioned above, the powder material may contain components other than the above coated particles, and examples of the components include a laser absorbent and a flow agent.

1-2-1. Laser Absorbent

From the viewpoint of more efficient conversion of light energy of laser into heat energy, the powder material may further contain a laser absorbent. The laser absorbent is only required to be a material that absorbs laser at a wavelength to be used to generate heat. Examples of such a laser absorbent include carbon powder, nylon resin powder, pigments, and dyes. Only one of these laser absorbent may be used or two or more of these may be used in combination.

The amount of the laser absorbent can be appropriately set in the range where the coated particles are easily fused with each other. For example, the amount can be more than 0 mass % and less than 3 mass % based on the total mass of the powder material.

1-2-2. Flow Agent

The powder material may further contain a flow agent, from the viewpoint of improving the flowability of the powder material and making the powder material easy to handle on producing a three-dimensional shaped object. The flow agent is only required to be a material having a small friction coefficient and having self-lubricity. Examples of such a flow agent include silicon dioxide and boron nitride. Only one of these flow agents may be used or two of these may be used in combination.

The amount of the flow agent can be appropriately set in a range where the flowability of the powder material is improved and fusing of the coated particles having a core-shell structure sufficiently occurs. The amount can be, for example, more than 0 mass % and less than 2 mass % based on the total mass of the powder material.

2. Method for Producing Powder Material

The method for producing the above powder material is not particularly limited, and the powder material can be produced by a known method. For example, when the powder material contains only the coated particles mentioned above, the coated particles can be used as they are as the powder material. Meanwhile, when the powder material contains coated particles and other materials, the powder material can be produced by stirring and mixing the other components made into a powder form together with the coated particles. Hereinbelow, the method for preparing coated particles will be described.

(Method for Preparing Coated Particles)

The method for preparing coated particles mentioned above is not particularly limited as long as the method enables a shell material composed of an inorganic material to be formed on the peripheral surface of a core resin. However, the method preferably includes a step of providing particles composed of a core resin, and a step of attaching a metal alkoxide compound to the peripheral surface of the core resin and polycondensing the metal alkoxide compound, from the viewpoint that the shell material is likely to be formed into a sheet-like material having a uniform thickness and further, the coating ratio of the core resin by the shell material is enhanced

In the step of providing particles composed of a core resin, the core resin may be prepared from various materials. The preparation method may be the same as a known method for preparing resin particles. As the core resin, a commercially available product may be used.

The step of attaching a metal alkoxide compound to the surface of the particle composed of the core resin and polycondensing the metal alkoxide compound can be a step of immersing the particles composed of the core resin in a composition containing the metal alkoxide compound and stirring the particles in the composition for a certain time. Immersion of the core resin in the composition containing the metal alkoxide compound can attach the metal alkoxide compound evenly to the surface of the core resin. Then, stirring in this state for a certain time causes hydrolysis and polycondensation of the metal alkoxide compound. As a result, a film (shell material) composed of the inorganic material (metal oxide) is formed on the peripheral surface of the core resin.

Examples of the metal alkoxide compound for use in formation of the shell material include alkoxysilanes such as tetraethoxysilane, tetramethoxysilane, tetraisopropoxysilane, tetrabutoxysilane, 3-methacryloyloxy propyltrimethoxysilane, alkoxy titaniums such as tetraisopropyl orthotitanate, tetrabutyl orthotitanate, and tetraethyl orthotitanate, alkoxy zirconium such as zirconium butoxide, zirconium propoxide, and zirconium ethoxide. Of these, at least one member selected from the group consisting of tetraethoxysilane, tetraisopropyl orthotitanate, and zirconium butoxide is preferable, from the viewpoint of reactivity and the like.

The composition in which the core resin is immersed may contain a solvent as required, and examples of the solvent include alcohols such as ethanol, isopropanol, and butanol, and water. The concentration of the metal alkoxide in the composition is preferably 1 to 30 mass %, more preferably 5 to 20 mass %. When the concentration of the metal alkoxide is in the range, the metal alkoxide is likely to attach evenly to the surface of the core resin, and the coating ratio of the core resin by the shell material is likely to increase.

The time for the contact between the core resin and the metal alkoxide (the stirring time described above) in the composition containing the metal alkoxide, which is appropriately selected depending on the concentration of the metal alkoxide and the like, is preferably usually 10 minutes to 6 hours, more preferably 30 minutes to 3 hours. Additionally, in the meantime, stirring may be performed under heating or at normal temperature.

After the reaction, particles are dried as required. Then, coated particles each including the core resin coated with the shell material can be provided.

3. Method for Producing Three-Dimensional Shaped Object

Subsequently, the method for producing a three-dimensional shaped object by using the powder material mentioned above will be described. The method for producing a three-dimensional shaped object of the present embodiment can be performed in the same manner as a usual powder bed fusion method, except that the powder material is used. Specifically, the method can include (1) thin layer formation step of forming a thin layer composed of the powder material mentioned above, (2) preheating step of preheating the powder material, and (3) laser beam irradiation step of selectively irradiating the preheated thin layer composed of the powder material with a laser beam to form a shaped object layer in which coated particles, contained in the powder material, are fused with each other. Then, a three-dimensional shaped object can be produced by repeating steps (1) to (3) a plurality of times to laminate shaped object layers. Step (1) and step (2) may be performed in any order.

3-1. Thin Layer Formation Step (Step (1))

In the present step, a thin layer of the powder material is formed. For example, the powder material supplied from a powder supply section is spread evenly on a shaping stage by a recoater. The thin layer may be formed directly on the shaping stage or may be formed on an already spread powder material or on an already shaped object layer.

The thickness of the thin layer is made equivalent to the thickness of a desired shaped object layer. The thickness of the thin layer can be set in accordance with the accuracy of a three-dimensional shaped object to be produced, and is typically 0.01 mm or more and 0.30 mm or less. When the thickness of the thin layer is set at 0.01 mm or more, it is possible to prevent fusing of coated particles in the underneath layer due to laser beam irradiation for forming the following shaped object layer. The powder can be uniformly spread. When the thickness of the thin layer is set at 0.30 mm or less, laser beam energy can be transferred to the lower portion of the thin layer and the coated particles contained in the powder material constituting the thin layer can be sufficiently fused over the entire thickness direction. From the viewpoint, the thickness of the thin layer is more preferably 0.01 mm or more and 0.10 mm or less. From the viewpoint of more sufficiently fusing coated particles over the entire thickness direction of the thin layer and making cracking in the shaped object layer to be more unlikely to occur, the thickness of the thin layer is more preferably set such that a difference between the thickness and a beam spot diameter of a laser beam described hereinafter becomes 0.10 mm or less.

3-2. Preheating Step (Step (2))

In the present step, the powder material is preheated. As mentioned above, step (1) and step (2) may be performed in any order. For example, a thin layer may be formed after the powder material is preheated, or the powder material may be preheated after the thin layer is formed.

The preheating temperature can be a temperature at about which the shell material does not break due to expansion of the core resin, for example, a temperature less than the softening temperature of the core resin. The preheating temperature is preferably a temperature of the softening temperature of the core resin −5° C. or higher. The preheating temperature also can be determined based on the storage elastic modulus of the core resin. For example, the preheating temperature can be a temperature at which the storage elastic modulus G of the core resin of the coated particles is 10⁶ Pa or less and the like. The specific preheating temperature is appropriately selected in accordance with the type of core resin, the average linear expansion coefficient ratio between the core resin and the shell material, and the like, and is preferably 50° C. or higher and 300° C. or lower, more preferably 100° C. or higher and 250° C. or lower, further preferably 140° C. or higher and 250° C. or lower, further preferably 140° C. or higher and 200° C. or lower.

In the meantime, the heating time is preferably 1 to 30 seconds, more preferably 5 to 20 seconds. When the heating temperature and the heating time are each set in the above range, the core resin in the coated particles can be sufficiently softened or dissolved, and a three-dimensional shaped object can be produced with the amount of the laser energy.

3-3. Laser Beam Irradiation Step (Step (3))

In the present step, the thin layer composed of the preheated powder material is selectively irradiated, at the positions where a shaped object layer is to be formed, with a laser beam to break the shell material of the coated particles at desired positions. Then, the core resin of the coated particle and that of the other coated particle in the positions are fused with each other. The melted coated particles (core resin) are melt with adjacent coated particles (core resin) to form a fused body, thereby forming a shaped object layer. On this occasion, coated particles that have received the energy of the laser beam are also fused with an already-formed shaped object layer, also resulting in adhesion between adjacent layers.

The wavelength of a laser beam may be set within a range of wavelengths that are absorbed by the shell material. In this case, a difference between the wavelength of a laser beam and a wavelength at which the shell material has the highest absorptance is preferably small. An inorganic material generally absorbs light in various wavelength regions, and thus, laser beams having a broad wavelength bandwidth, such as CO₂ laser or the like are preferably used. For example, the wavelength of a laser beam can be 0.8 μm or more and 12 μm or less.

The output power of a laser beam may be set within a range in which the temperature of the coated particles can be raised and the shell material can break due to expansion of the core resin at a scanning speed of the laser described below. Specifically, the output power can be 5.0 W or more and 60 W or less. The output power of a laser beam is preferably 30 W or lower, more preferably 20 W or lower, from a viewpoint of lowering laser beam energy, reducing production costs, and simplifying the configuration of a production apparatus.

The scanning speed of a laser beam may be set within a range in which production costs are not raised and the configuration of the apparatus is not excessively complicated. Specifically, the scanning speed is preferably 1 m/s or more and 10 m/s or less, more preferably 2 m/s or more and 8 m/s or less, further preferably 3 m/s or more and 7 m/s or less. The beam diameter of a laser beam can be appropriately set in accordance with the accuracy of a three-dimensional shaped object to be produced.

3-4. Repeating of Step (1) to Step (3)

On producing a three-dimensional shaped object, step (1) to step (3) mentioned above are repeated any number of times. This allows shaped object layers to be laminated, providing a desired three-dimensional shaped object.

3-5. Additional Notes

At least step (3) is preferably performed under a reduced pressure or an inert gas atmosphere, from a viewpoint of preventing lowering in the strength of a three-dimensional shaped object due to oxidizing or the like of the coated particles (particularly the core resin) during fusing. The pressure on reducing the pressure is preferably 10⁻² Pa or lower, more preferably 10⁻³ Pa or lower. Examples of the inert gases that can be used in the present embodiment include nitrogen gas and noble gases. Among these inert gases, nitrogen (N₂) gas, helium (He) gas, or argon (Ar) gas is preferable from the viewpoint of availability. From a viewpoint of simplifying production steps, all of steps (1) to (3) are preferably performed under a reduced pressure or an inert gas atmosphere.

4. Three-Dimensional Shaping Apparatus

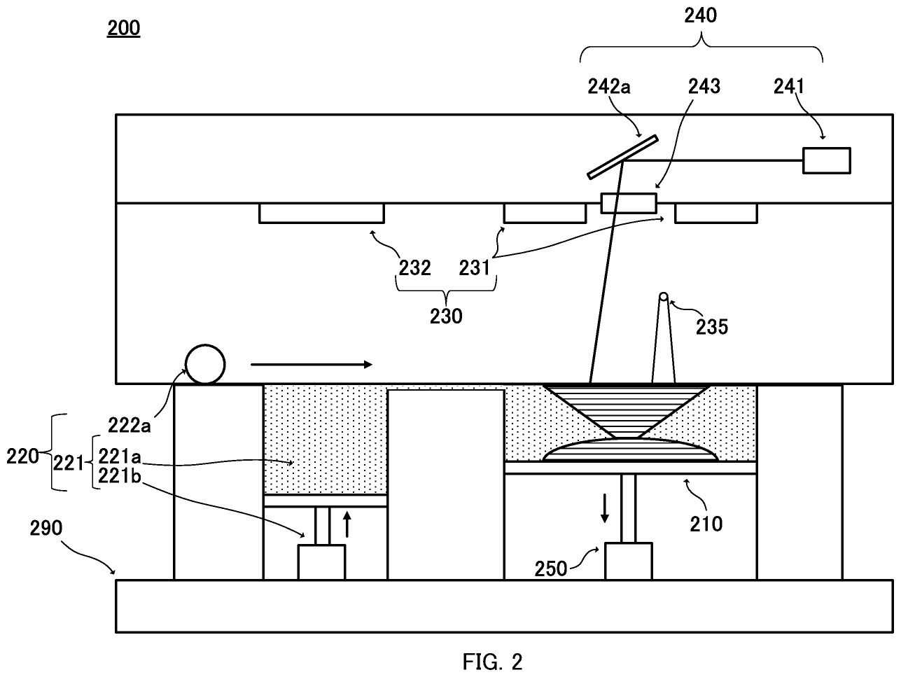

A three-dimensional shaping apparatus that can be used for the method for producing a three-dimensional shaped object described above will be described. A three-dimensional shaping apparatus that can be used in the present embodiment can be configured in the same manner as a known three-dimensional shaping apparatus. Specifically, three-dimensional shaping apparatus 200 according to the present embodiment includes, as illustrated in the schematic side view of FIG. 2, shaping stage 210 positioned inside an opening, thin layer forming section 220 that forms a thin layer composed of a powder material, preheating section 230 that preheats the powder material, laser irradiation section 240 that irradiates the thin layer with a laser beam, stage support section 250 that supports shaping stage 210 at a position movable in the vertical direction, and base 290 that supports each section described above.

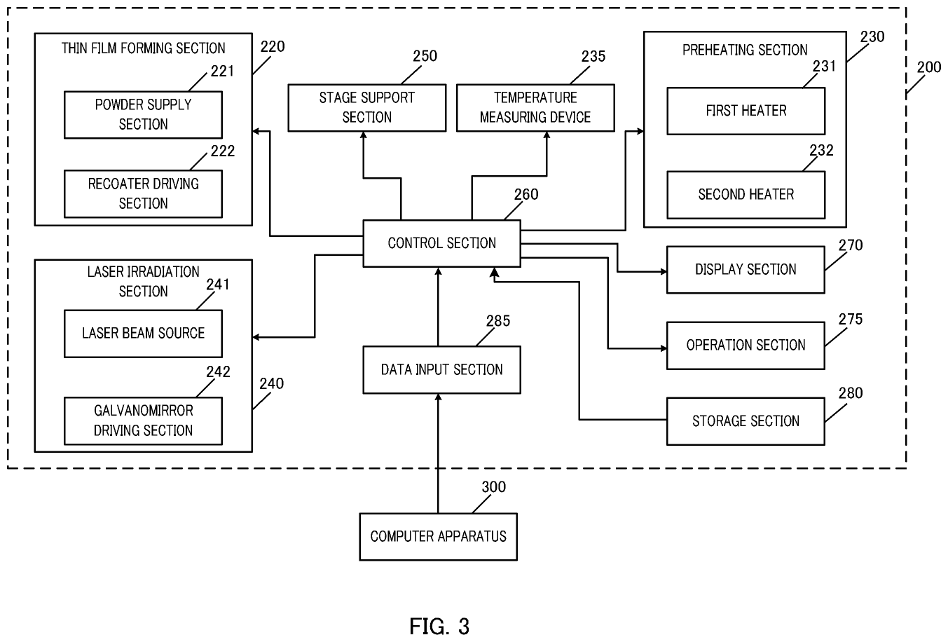

The main part of the control system of three-dimensional shaping apparatus 200 is shown in FIG. 3. As shown in FIG. 3, three-dimensional shaping apparatus 200 may include control section 260 that controls thin layer forming section 220, preheating section 230, laser irradiation section 240, and stage support section 250 to perform formation and lamination of shaped objects, display section 270 that displays various types of information, operation section 275 including a pointing device and the like that receives instructions from a user, storage section 280 that stores various types of information, such as a control program executed by control section 260, and data input section 285 that transmits and receives various types of information including three-dimensional shaping data to and from an external apparatus. Three-dimensional shaping apparatus 200 may include temperature measuring device 235 that measures the surface temperature of a thin layer formed on shaping stage 210. Computer apparatus 300 that creates data for three-dimensional shaping may be connected to three-dimensional shaping apparatus 200.

Shaping stage 210 is controlled elevatably and lowerably. On shaping stage 210, a thin layer is formed by thin layer forming section 220, powder material is preheated by preheating section 230, and a laser beam is directed by laser irradiation section 240. Then, shaped objects formed by these are laminated to form a three-dimensional shaped object.

Thin layer forming section 220 can include powder supply section 221 including powder material storage section 221a that stores a powder material and supply piston 221b that is provided in the bottom portion of powder material storage section 221a to rise and fall in the opening, and recoater 222a that spreads the powder material supplied by powder supply section 221 evenly on shaping stage 210 to form a thin layer of the powder material. In the present embodiment, the upper face of the opening of powder material storage section 221a is positioned substantially coplanarly to the upper face of the opening where shaping stage 210 is elevated or lowered (to form a three-dimensional shaped object).

Powder supply section 221 may be configured to include a powder material storage section (not shown) provided above shaping stage 210 in the vertical direction and a nozzle (not shown) that discharges the powder material stored in the powder material storage section by a predetermined amount. In this case, discharging the powder material from the nozzle evenly onto shaping stage 210 enables a thin layer to be formed.

Preheating section 230 may be one that can heat the powder material at regions where a shaped object layer is to be formed and can maintain the temperature. In the present embodiment, preheating section 230 includes first heater 231 that can heat the surface of a thin layer formed on shaping stage 210 and second heater 232 that heats the powder material before supplied onto the shaping stage. Preheating section 230 may include only either one of these heaters. Preheating section 230 may be configured to selectively heat a region at which a shaped object layer is to be formed. Alternatively, preheating section 230 may be configured to preheat the entire inside of the apparatus to adjust the surface of the above thin layer to a predetermined temperature.

Temperature measuring device 235 may be one that can contactlessly measure the surface temperature of a thin layer, particularly the surface temperature of a region at which a shaped object layer is to be formed and, for example, can be an infrared sensor or optical pyrometer.

Laser irradiation section 240 can be configured to include laser beam source 241 and galvanomirror 242a. Laser irradiation section 240 may include laser window 243 that transmits a laser beam and a lens (not shown) that adjusts the focal distance of a laser beam to the surface of the thin layer. Laser beam source 241 may be a light source that emits a laser beam having the wavelength at the output. Examples of laser beam source 241 include a YAG laser beam source, a fiber laser beam source, and a CO₂ laser beam source. Galvanomirror 242a may include an X mirror that reflects a laser beam emitted from laser beam source 241 and scan the laser beam in the X direction and a Y mirror that scan the laser beam in the Y direction. Laser window 243 may be one composed of a material that transmits a laser beam.

Stage support section 250 may be one that supports shaping stage 210 at a position movable in the vertical direction. That is, shaping stage 210 is configured to be precisely movable in the vertical direction by means of stage support section 250. As stage support section 250, various configurations may be employed. Stage support section 250 can be configured with, for example, a retaining member that retains shaping stage 210, a guide member that guides this retaining member in the vertical direction, a ball screw that engages with a screw hole provided in the guide member, and the like.

Control section 260 includes a hardware processor, such as a central processing unit, and controls operations of entire three-dimensional shaping apparatus 200 during shaping operations of a three-dimensional shaped object.

Control section 260 may be configured, for example, to convert three-dimensional shaping data obtained by data input section 285 from computer apparatus 300 into a plurality of slice data that is thinly sliced in the lamination direction of shaped object layers. The slice data are shaping data of each shaped object layer for shaping a three-dimensional shaped object. The thickness of the slice data, that is, the thickness of the shaped object layer, coincides with a distance corresponding to the thickness of one object layer (lamination pitch).

Display section 270 can be a liquid crystal display or a monitor, for example.

Operation section 275 can include a pointing device, such as a keyboard or mouse, and may be equipped with a various operation keys, such as a numeric key pad, an execution key, and a start key.

Storage section 280 can include various storage media, such as a ROM, a RAM, a magnetic disk, an HDD, and an SSD.

Three-dimensional shaping apparatus 200 may include a pressure-reducing section (not shown), such as a pressure-reducing pump, that reduces pressure inside the apparatus under the control of control section 260, or an inert gas supply section (not shown) that supplies an inert gas inside the apparatus under the control of control section 260.

Here, the three-dimensional shaping method using three-dimensional shaping apparatus 200 of the present embodiment will be specifically described. Control section 260 converts three-dimensional shaping data obtained from computer apparatus 300 by data input section 285 into a plurality of slice data that is thinly sliced in the lamination direction of shaped object layers. Control section 260 then controls the following operations in three-dimensional shaping apparatus 200.

Powder supply section 221 drives a motor and a driving mechanism (neither shown) in accordance with supply information, which is output from control section 260, to move a supply piston upward in the vertical direction (arrow direction in FIG. 2), and thus push a powder material coplanarly to the shaping stage in the horizontal direction.

Subsequently, recoater driving section 222 moves recoater 222a in the horizontal direction (arrow direction in the figure) in accordance with thin layer formation information, which is output from control section 260, to transfer the powder material onto shaping stage 210 while pressing the powder material such that the thickness of the thin layer becomes the thickness of one shaped object layer.

Preheating section 230 heats, in accordance with temperature information, which is output from control section 260, the powder material only in a predetermined region or the entire inside of the apparatus. The above temperature information can be, for example, a temperature determined by control section 260 based on the softening temperature data of a material constituting the core resin, which is input from data input section 285 and the like. Preheating section 230 may start heating after a thin layer is formed, or may heat an area corresponding to the surface of a thin layer to be formed or the inside of the apparatus before the thin layer is formed.

Laser irradiation section 240 then emits a laser beam from laser beam source 241 adaptably to a region where a three-dimensional shaped object is to be formed based on each slice data, on the thin layer, in accordance with laser irradiation information, which is output from control section 260, and drives galvanomirror 242a by galvanomirror driving section 242 to scan with the laser beam. Through the laser beam irradiation, at least a portion of coated particles (at least the core resin) contained in the powder material is fused to form a shaped object layer.

Afterwards, stage support section 250 drives a motor and a driving mechanism (neither shown) in accordance with position control information, which is output from control section 260, to move shaping stage 210 downward in the vertical direction (arrow direction in the figure) by a lamination pitch.

Display section 270 displays various types of information and messages to be recognized by a user, as required, under the control of control section 260. Operation section 275 receives various input operations by a user and outputs operation signals in response to the input operations to control section 260. For example, a virtual three-dimensional shaped object to be formed may be displayed on display section 270 to confirm whether a desired shape is formed, and corrections may be made from operation section 275 if a desired shape is not formed.

Control section 260 stores data in storage section 280 or retrieves data from storage section 280 as required.

Shaped object layers are laminated by repeating these operations to produce a three-dimensional shaped object.

### EXAMPLES

Hereinbelow, specific examples of the present invention will be described. The examples, however, shall not be construed as limiting the technical scope of the present invention.

### Example 1

As a core resin material, polyamide 12 (PA12, DAIAMID L1600 manufactured by Daicel-Evonik Ltd. (“DAIAMID” is a registered trademark of the company)) was provided. The resin particulates were pulverized by a mechanical pulverization method until the average particle size measured by a laser diffraction-type particle size analyzer equipped with a wet disperser (HELOS manufactured by Sympatec GmbH) reached a value of 50 μm.

To 100 parts by mass of the pulverized PA12 particles, 180 parts by mass of ethanol and 420 parts of pure water were added, and ammonia water was added thereto such that the pH reached 11.0. To the mixed liquid under stirring at 400 rpm, 100 parts by mass of tetraethoxysilane (TEOS) was added and allowed to react for 10 minutes. Then, solid-liquid separation was performed by vacuum filtration, and the solid was dried at 80° C. for 1 hour to obtain coated particles each having a core resin coated with the shell material.

The average linear expansion coefficients of the core resin and the shell material at 20 to 100° C. were each identified by a TMA (TMA7100 manufactured by Hitachi High-Tech Science Corporation). The softening temperature of the core resin was measured as follows. An aluminum plate having a diameter of 5 cm on which 1 g of the core resin having an average particle size of 50 μm was spread was placed on a hot plate, and the temperature of the hot plate was raised in increments of 5° C. Then, the fusing state of the core resin was examined at each temperature, and the temperature at which the beginning of the fusing was observed was identified as the softening temperature of the core resin.

### Example 2

Coated particles were obtained in the same manner as in Example 1 except that the reaction time for TEOS was extended to 30 minutes.

### Example 3

Coated particles were obtained in the same manner as in Example 1 except that the reaction time for TEOS was extended to 2 hours.

### Example 4

Coated particles were obtained in the same manner as in Example 1 except that the reaction time for TEOS was extended to 2.5 hours.

### Example 5

Coated particles were obtained in the same manner as in Example 1 except that the reaction time for TEOS was extended to 6 hours.

### Example 6

Coated particles were obtained in the same manner as in Example 3 except that TEOS was replaced by tetraisopropyl orthotitanate.

### Example 7

Coated particles were obtained in the same manner as in Example 3 except that TEOS was replaced by zirconium butoxide.

### Example 8

Coated particles were obtained in the same manner as in Example 3 except that the core resin material was replaced by polyamide 6 (PA6, Amilan CM1001 manufactured by Toray Industries, Inc. (“Amilan” is a registered trademark of the company)).

### Example 9

Coated particles were obtained in the same manner as in Example 5 except that the core resin material was replaced by polyamide 6 (PA6, Amilan CM1001 manufactured by Toray Industries, Inc. (“Amilan” is a registered trademark of the company).

### Example 10

Coated particles were obtained in the same manner as in Example 6 except that the core resin material was replaced by polyamide 6 (PA6, Amilan CM1001 manufactured by Toray Industries, Inc. (“Amilan” is a registered trademark of the company)).

### Comparative Example 1

Polyamide 12 (PA12, manufactured by Daicel-Evonik Ltd., DAIAMID L1600 (“DAIAMID” is a registered trademark of the company)) particles were solely used.

### Comparative Example 2

Coated particles were obtained in the same manner as in Example 6 except that polyether sulfone (PES, SUMIKAEXCEL 3601GL30 manufactured by Sumitomo Chemical Company (“SUMIKAEXCEL” is a registered trademark of the company)) was used as the core particles.

### Comparative Example 3

Coated particles were obtained in the same manner as in Example 3 except that a vinylidene fluoride resin (Solef 6012 manufactured by Solvay S.A. (“Solef” is a registered trademark of the company)) was used as the core particles.

[Evaluation]

Powder materials prepared in Examples and Comparative Examples were subjected to the following laser shaping test, evaluation of thickness of shell material, evaluation of breakability of shell material, evaluation of shaping properties, and evaluation of recycling properties of coated particles.

<Laser Shaping Test>

A powder material was spread over the shaping stage of a three-dimensional shaping apparatus in accordance with a powder bed fusion method to form a thin layer having a thickness of 0.1 mm. An area of 15 mm in length×20 mm in width in this thin layer was irradiated with laser from a 50 W fiber laser (manufactured by SPI Lasers Limited) equipped with a galvanometer scanner for YAG wavelengths under the following conditions, and 10 such thin layers were laminated to form each shaped object.

Laser wavelength: 1.07 am

Beam diameter: 170 am on thin layer surface

Scan interval: 0.2 mm

Laser: output 20 W

Scanning speed: 5,000 mm/sec

Standby temperature: set at softening temperature of the core resin −25° C.

<Evaluation of Thickness of Shell Material>

Coated particles were dispersed in a photocurable resin (D-800 manufactured by JEOL Ltd.) and then photocured to form a block. A flake sample having a thickness of 100 to 200 nm was cut from the above sample using a microtome equipped with diamond teeth and placed on a grid having a support film for transmission electron microscope observation. The above grid was mounted on a scanning transmission electron microscope (JSM-7401F manufactured by JEOL Ltd.) and a light field image was imaged under the following conditions.

(Imaging Method)

Accelerating voltage: 30 kV

Magnification: 10,000×

Cross sections of a large number of coated particles were imaged by the TEM. The interface between the core resin and the shell material of each of 10 coated particles randomly selected from the images obtained was examined. The thickness of the shell material of each coated particle was actually measured at 10 points, and the average value thereof was determined and taken as the average thickness of the shell material.

<Evaluation of Breakability of Shell Material>

Coated particles were heated to between the softening temperature of the core resin or higher and the softening temperature+50° C. or lower, and the breakability of the shell material was examined by TEM observation. Specifically, 10 coated particles having a coating ratio of its core resin with a shell material before heating of 100% were selected and the state of the coated particles was examined by TEM observation. Points at which the shell material is lacking appear discolored by TEM observation. When discoloration occurred, the shell material was determined to have broken. Evaluation was performed based on the following criteria.

B: The shell material of 5 or more out of 10 coated particles did not break at the softening temperature of the core resin or lower, and the shell material of 5 or more out of 10 coated particles broke at the softening temperature of the core resin or higher.

C: The shell material of 5 or more out of 10 coated particles broke at the softening temperature of the core resin or lower, or the shell material of 5 or more out of 10 coated particles did not break even at higher than the softening temperature of the core resin+50° C.

<Evaluation of Shaping Properties>

The dimensions in the length and width directions of each shaped object were measured by digital calipers (Super Caliper CD67-SPS/PM manufactured by Mitutoyo Corporation, “Super Caliper” is a registered trademark of the company). Differences between the dimensions intended to be produced (15 mm in length x 20 mm in width) and the dimensions of the length and width measured were averaged, and the value obtained was taken as the deviation in the shaping accuracy.

The shaping properties were evaluated based on the following criteria.

A: The shaping accuracy was less than 0.1 mm, and a shaped object having a high accuracy was obtained.

B: The shaping accuracy was less than 0.5 mm and 0.1 mm or more, and a shaped object as designed was obtained.

C: The shaping accuracy was 0.5 mm or more, and a shaped object as designed was not obtained.

<Evaluation of Recycling Properties of Particles>

In the powder material used for shaping, 10 g of the powder material at each portion not subjected to laser irradiation was weighed, transferred on a metal mesh sieve having an opening size of 2 mm, and subjected to vibration for 20 seconds. The powder material left on the sieve was weighed.

The recycling properties were evaluated based on the following criteria.

A: The weight of the powder material left on the sieve was less than 5%.

B: The weight of the powder material left on the sieve was 5% or more and less than 10%.

C: The weight of the powder material left on the sieve was 10% or more.

TABLE 1

| | | | | Average linear | Average linear | | | | | |
|---|---|---|---|---|---|---|---|---|---|---|
| | | | | expansion | expansion | Ratio between | | | | |
| | | | | coefficient | coefficient | average linear | | | | |
| | | | Core resin | of core resin | of shell material | expansion | Shell | Break- | | |
| | | | melting | at 20 to | at 20 to | coefficients | material | ability | | |
| | Core | Shell | temperature | 100° C. | 100° C. | (core resin/shell | thickness | of shell | Shaping | Recycling |
| | resin | material | (° C.) | (×10⁻⁶/K) | (×10⁻⁶/K) | material) | (nm) | material | properties | properties |
| Example 1 | PA12 | SiO₂ | 185 | 100 | 0.5 | 200 | 0.5 | B | B | B |
| Example 2 | PA12 | SiO₂ | 185 | 100 | 0.5 | 200 | 1 | B | B | A |
| Example 3 | PA12 | SiO₂ | 185 | 100 | 0.5 | 200 | 40 | B | B | A |
| Example 4 | PA12 | SiO₂ | 185 | 100 | 0.5 | 200 | 49 | B | B | A |
| Example 5 | PA12 | SiO₂ | 185 | 100 | 0.5 | 200 | 100 | B | B | B |
| Example 6 | PA12 | Titanium | 185 | 100 | 8.57 | 11.7 | 40 | B | A | A |
| | | oxide | | | | | | | | |
| Example 7 | PA12 | Zirconia | 185 | 100 | 10 | 10.0 | 40 | B | A | A |
| Example 8 | PA6 | SiO₂ | 210 | 81.5 | 0.5 | 163 | 40 | B | A | A |
| Example 9 | PA6 | Titanium | 210 | 81.5 | 8.57 | 9.5 | 40 | B | A | A |
| | | oxide | | | | | | | | |
| Example 10 | PA6 | Zirconia | 210 | 81.5 | 10 | 8.2 | 40 | B | A | A |
| Comparative | PA12 | — | 185 | 100 | — | — | — | — | C | C |
| Example 1 | | | | | | | | | | |
| Comparative | PES | Zirconia | 225 | 23 | 10 | 2.3 | 40 | C | C | A |
| Example 2 | | | | | | | | | | |
| Comparative | PVDF | SiO₂ | 175 | 140 | 0.5 | 280 | 40 | C | C | C |
| Example 3 | | | | | | | | | | |

As shown in Table 1, when the average linear expansion coefficient of the core resin at 20 to 100° C. was 5 to 240 based on the average linear expansion coefficient of the shell material at 20 to 100° C., the shell material broke in the temperature range between the softening temperature of the shell material or higher and the softening temperature+50° C. or lower (Examples 1 to 10). That is, it was possible to sufficiently bind the core resin of a particle with the core resin of the adjacent particle. In this case, the shaping properties, recyclability, and recycling properties were also satisfactory. When the thickness of the shell material was 1 to 49 nm, particularly, the recyclability was likely to be satisfactory (Examples 2 to 4 and Examples 6 to 10). When the thickness of the shell material is 1 nm or more, it is presumed that the shell material was unlikely to break on preheating. Meanwhile, when the thickness of the shell material was extremely large, fine cracking called cracks was more likely to occur in the shell material on forming the shell material, and the shell became more likely to split due to preheating (standby temperature). Accordingly, it is presumed that the recycling properties was lowered.

In contrast, the particles having no shell material of Comparative Example 1 had poor shaping properties and further low recycling properties. In Comparative Example 2, in which the above average linear expansion coefficient of the core resin is less than 5 based on the above average linear expansion coefficient of the shell material, the recycling properties was satisfactory, but the shell material was unlikely to break by thermal expansion of the core resin in the desired temperature range. In Comparative Example 2, even when the softening temperature of the core resin was reached, there were particles of which shell material had not broken. Such particles came off from the shaped object after shaping, and thus, shaping properties were low. In contrast, in Comparative Example 3, in which the average linear expansion coefficient of the core resin is more than 240 based on the average linear expansion coefficient of the shell material, the shaping properties and the recyclability were poor. It is presumed that the extremely high average linear expansion coefficient ratio caused the shell material to break on preheating. It is also presumed that the extremely high linear expansion coefficient of the core resin led to lowering of the shaping properties of the resulting three-dimensional shaped object.

This application claims the benefit of Japanese Patent Application No. 2017-030904 filed on Feb. 22, 2017, the disclosure of which including the specification and drawings is incorporated herein by reference in its entirety.

### INDUSTRIAL APPLICABILITY

The powder material of the present invention can be preheated sufficiently and has high reusability. Thus, the present invention is conceived to contribute to further spread of the powder bed fusion method.

### REFERENCE SIGNS LIST

100 Coated particle
101 Core particle
102 Shell material
200 Three-dimensional shaping apparatus
210 Shaping stage
220 Thin film forming section
221 Powder supply section
222 Recoater driving section
222a Recoater
230 Preheating section
231 First heater
232 Second heater
235 Temperature measuring device
240 Laser irradiation section
241 Laser beam source
242 Galvanomirror driving section
242a Galvanomirror
243 Laser window
250 Stage support section
260 Control section
270 Display section
275 Operation section
280 Storage section
290 Base
285 Data input section
300 Computer apparatus

1. A powder material to be used in a method for producing a three-dimensional shaped object by repeating preheating of a powder material containing coated particles and selective laser beam irradiation onto the thin layer of the powder material to laminate a plurality of shaped object layers in which at least portion of the coated particle is fused with at least portion of another coated particle, wherein
the coated particle comprises a core resin and a shell material with which the core resin is coated and which is composed of an inorganic material,
the average linear expansion coefficient of the core resin in the range of 20 to 100° C. is 5 to 240 based on the average linear expansion coefficient of the shell material in the range of 20 to 100° C., and
the shell material breaks in the range of the softening temperature of the core resin or higher and the softening temperature+50° C. or lower.

2. The powder material according to claim 1, wherein the shell material of the coated particle has a thickness of 1 to 49 nm.

3. The powder material according to claim 1, wherein the shell material is composed of an inorganic material comprising silicon.

4. A method for producing a coated particle comprising a core resin and a shell material with which the core resin is coated, the method comprising:
providing a core resin, and
attaching a metal alkoxide compound to a peripheral surface of the core resin and polycondensing the metal alkoxide compound.

5. The method for producing a coated particle according to claim 4, wherein the metal alkoxide compound is at least one member selected from the group consisting of tetraethoxysilane, tetraisopropyl orthotitanate, and zirconium butoxide.

6. A method for producing a three-dimensional shaped object, comprising:
forming a thin layer composed of the powder material according to claim 1,
preheating the powder material,
selectively irradiating the preheated thin layer with a laser beam to form a shaped object layer in which at least portion of the coated particle is fused with at least portion of the other coated particle, the preheated thin layer being composed of the powder material, wherein
the forming of the thin layer, the preheating of the powder material, and the selectively irradiating of the preheated thin layer are repeated a plurality of times and the shaped object layers are laminated to form a three-dimensional shaped object.

7. A three-dimensional shaping apparatus, comprising:
a shaping stage;
a thin layer former that forms a thin layer of the powder material according to claim 1 on the shaping stage;
a preheater that preheats the powder material;
a laser irradiator that irradiates the preheated thin layer with laser to form a shaped object layer in which at least portion of the coated particle is fused with at least portion of another coated particle, the preheated thin layer being composed of the powder material;
a stage supporter that supports the shaping stage at a position movable in a vertical direction of the shaping stage; and
a controller that controls the thin layer former, the preheater, the laser irradiator, and the stage supporter to form the shaped object layer repeatedly and laminate the formed shaped object layers.
